(19) United States
(12) Patent Application Publication
(10) Pub. No.: US 2025/0094832 A1
(43) Pub. Date: Mar. 20, 2025

(54) SYSTEMS AND METHODS FOR CLUSTERING TIME SERIES DATA BASED ON PATTERN-FOCUSED DISTANCE METRICS AND DYNAMIC WEIGHT SELECTION

(71) Applicant: Verizon Patent and Licensing Inc., Basking Ridge, NJ (US)

(72) Inventors: Nilanjan Das KHAN, Bangalore (IN); Keshri NANDAN, Noida (IN); Tanmoy GAYEN, Bangalore (IN)

(73) Assignee: Verizon Patent and Licensing Inc., Basking Ridge, NJ (US)

(21) Appl. No.: 18/470,594

(22) Filed: Sep. 20, 2023

(51) Int. Cl. G06N 5/022; G06Q 30/0204

(52) U.S. Cl. CPC G06N 5/022; G06Q 30/0204

(57) ABSTRACT

A device may receive time series data, and may convert the time series data into binary data. The device may calculate Hamming distances for the binary data, and may translate the time series data to vectors that capture patterns over a time period of the time series data. The device may calculate vector Euclidean distances for the vectors, and may calculate Euclidean distances for the time series data. The device may select weights for the Hamming distances, the vector Euclidean distances, and the Euclidean distances, and may apply the weights to the Hamming distances, the vector Euclidean distances, and the Euclidean distances. The device may process the time series data, the weighted Hamming distances, the weighted vector Euclidean distances, and the weighted Euclidean distances, with a clustering model, to generate clusters for the time series data, and may perform one or more actions based on the clusters.

### BACKGROUND

Time series data is a sequence of data points indexed in time order. These data points typically consist of successive measurements made from the same source over a fixed time interval and are used to track change over time.

### BRIEF DESCRIPTION OF THE DRAWINGS

FIGS. 1A-1G are diagrams of an example associated with clustering time series data based on pattern-focused distance metrics and dynamic weight selection.

FIG. 2 is a diagram illustrating an example of training and using a machine learning model.

FIG. 3 is a diagram of an example environment in which systems and/or methods described herein may be implemented.

FIG. 4 is a diagram of example components of one or more devices of FIG. 3.

FIG. 5 is a flowchart of an example process for clustering time series data based on pattern-focused distance metrics and dynamic weight selection.

### DETAILED DESCRIPTION OF EXAMPLE EMBODIMENTS

The following detailed description of example implementations refers to the accompanying drawings. The same reference numbers in different drawings may identify the same or similar elements.

Common machine learning methods of clustering time series data allocate more weight to magnitudes of the time series data than weights allocated to patterns of the time series data, with no flexibility to alter the weights. This creates challenges when a group of time series data are to be clustered or segmented based on pattern behavior rather than magnitudes. Clustering is used to segment data into subgroups depending on similar data behavior. A clustering model may determine distance metrics between all data points and may create groups among the data points based on the distance metrics. The distance metrics play a significant role in the clustering process because different clustering models capture specific characteristics of the data. Furthermore, the magnitude-based clustering of time series data is not scale-invariant and does not normalize the time series data before determining the distance metrics. The pattern-based clustering of time series data fails to consider the magnitude of the time series data and is more focused on the angular deviation of the time series data.

Clustering of time series data may be utilized for segmentation of similar cell towers based on network traffic. For example, network tower-level metrics, such as voice traffic volume, data traffic volume, energy consumption, and/or the like may directly affect key metrics, such as total bandwidth utilized, customer satisfaction, operating expenses, and/or the like. A telecommunication provider may require creation of meaningful groups of cell towers based on these features to enable efficient distribution of resources (e.g., bandwidth, maintenance, equipment upgrade budget, and/or the like) to maximize a return on investment (ROI) and minimize risk of outage. The clustering of time series data may be utilized for these purposes since the clustering provides a very robust and intuitive framework.

In another example, clustering of time series data may be utilized for customer churn mitigation. The clustering may help identify different segments of customers that are at risk of churning and the identified customers may be targeted with specific retention strategies to mitigate the churning. Customers identified as “at high risk of churn” may be grouped by clustering the customers based on their behavior, usage, and other attributes. Customer needs and pain-points may be determined to identify factors that are driving churn, such as price, product features, or customer service for each of the clusters. Broad retention strategies may be implemented at a cluster level along with personalized strategies to mitigate churn risk.

In still another example, clustering of time series data may be utilized for identifying potential patients prone to a certain disease. Clustering may be used to understand causes of certain diseases, such as Parkinson's disease, Alzheimer's disease, and/or the like. As the historical sample population affected by these diseases is low, clustering may provide better insights. Once a population is identified, clustering can help identify factors that may cause a disease, such as comorbidities, lifestyle, genetic patterns, historical medication patterns, and/or the like.

In another example, clustering of time series data may be utilized for credit risk modeling across consumer clusters. Clustering may be used in credit risk modeling to group borrowers together based on their similarities, such as spending patterns, income profiles, and demographics. This may help to identify borrowers who are most likely to default, may be used to tailor credit terms to specific needs of each borrower, and may improve accuracies of credit risk models.

Thus, current techniques for clustering time series data consume computing resources (e.g., processing resources, memory resources, communication resources, and/or the like), networking resources, and/or other resources associated with failing to cluster time series data based on magnitudes and a pattern behavior of the time series data, failing to enable allocation of different weights to the magnitudes and a pattern behavior of the time series data, generating incorrect clusters due to failing to cluster the time series data based on the magnitudes and the pattern behavior of the time series data, implementing incorrect decisions based on the incorrect clusters, and/or the like.

Some implementations described herein relate to a clustering system that clusters time series data based on pattern-focused distance metrics and dynamic weight selection. For example, the clustering system may receive time series data, and may convert the time series data into binary data. The clustering system may calculate Hamming distances for the binary data, and may translate the time series data to vectors that capture patterns over a time period of the time series data. The clustering system may calculate vector Euclidean distances for the vectors, and may calculate Euclidean distances for the time series data. The clustering system may select weights for the Hamming distances, the vector Euclidean distances, and the Euclidean distances, and may apply the weights to the Hamming distances, the vector Euclidean distances, and the Euclidean distances to generate weighted Hamming distances, weighted vector Euclidean distances, and weighted Euclidean distances. The clustering system may process the time series data, the weighted Hamming distances, the weighted vector Euclidean distances, and the weighted Euclidean distances, with a clustering model, to generate clusters for the time series data, and may perform one or more actions based on the clusters.

In this way, the clustering system clusters time series data based on pattern-focused distance metrics and dynamic weight selection. For example, the clustering system may provide a dynamically weighted distance definition for clustering of time series data in order to minimize intra-cluster variance and maximize the inter-cluster variance. The clustering system may linearly combine multiple distance measures to create a weighted distance metric. The clustering system may represent the time series data as binary data and may calculate Hamming distances between the binary data. The clustering system may utilize custom distance metric that captures a temporal variation of the time series data with respect to a trend component of the time series data. With the weighted distance metric, the clustering system may extract a hybrid of these characteristics, resulting in coherent clusters. Thus, the clustering system may conserve computing resources, networking resources, and/or other resources that would have otherwise been consumed by failing to cluster time series data based on magnitudes and a pattern behavior of the time series data, failing to enable allocation of different weights to the magnitudes and a pattern behavior of the time series data, generating incorrect clusters due to failing to cluster the time series data based on the magnitudes and the pattern behavior of the time series data, implementing incorrect decisions based on the incorrect clusters, and/or the like.

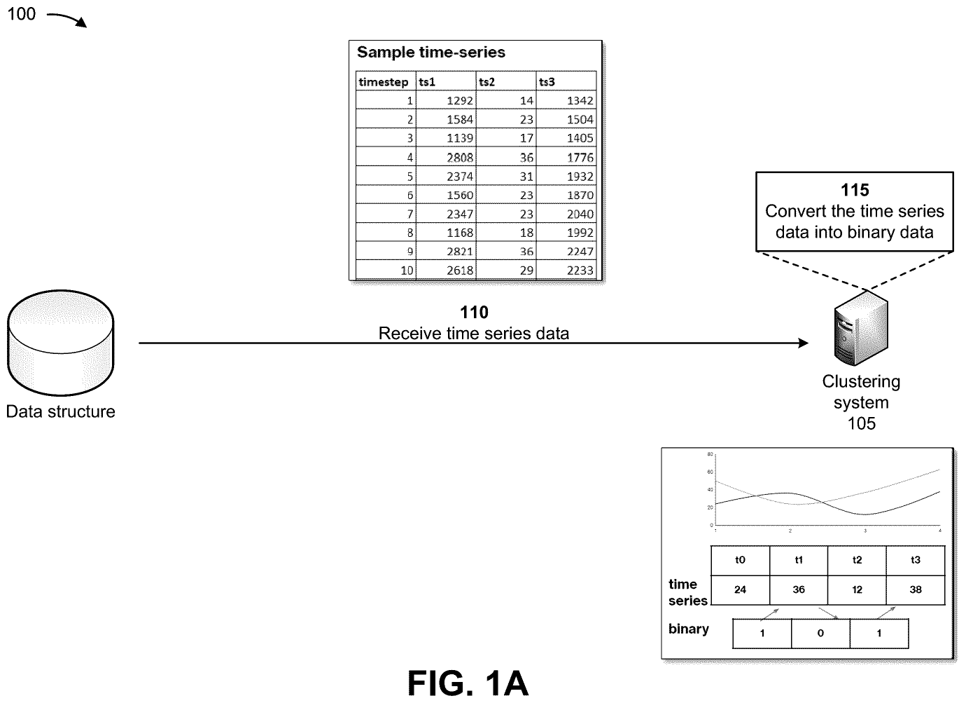

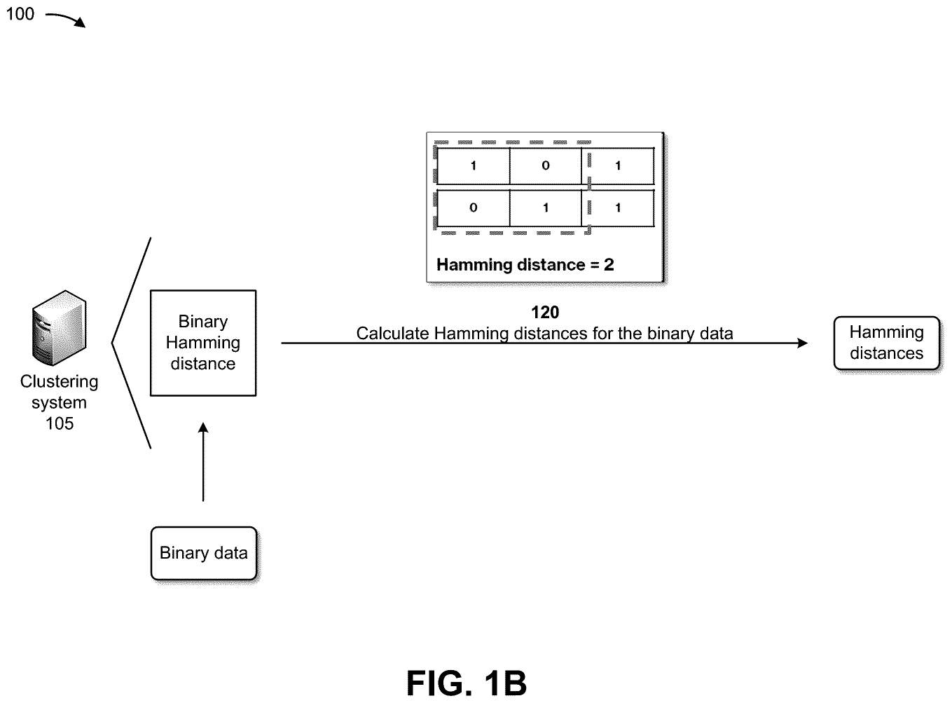

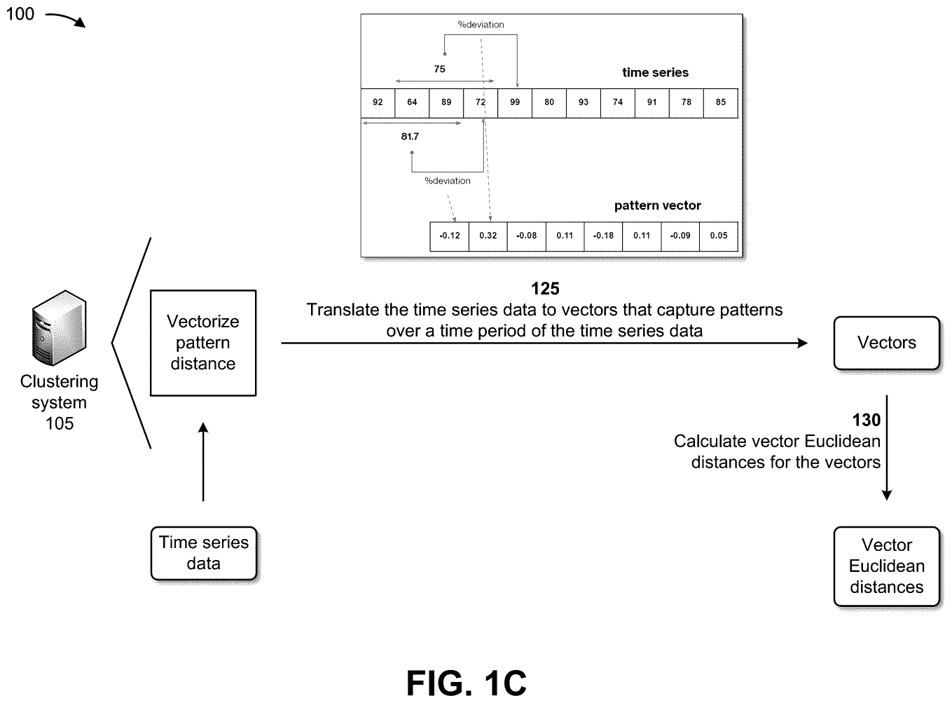

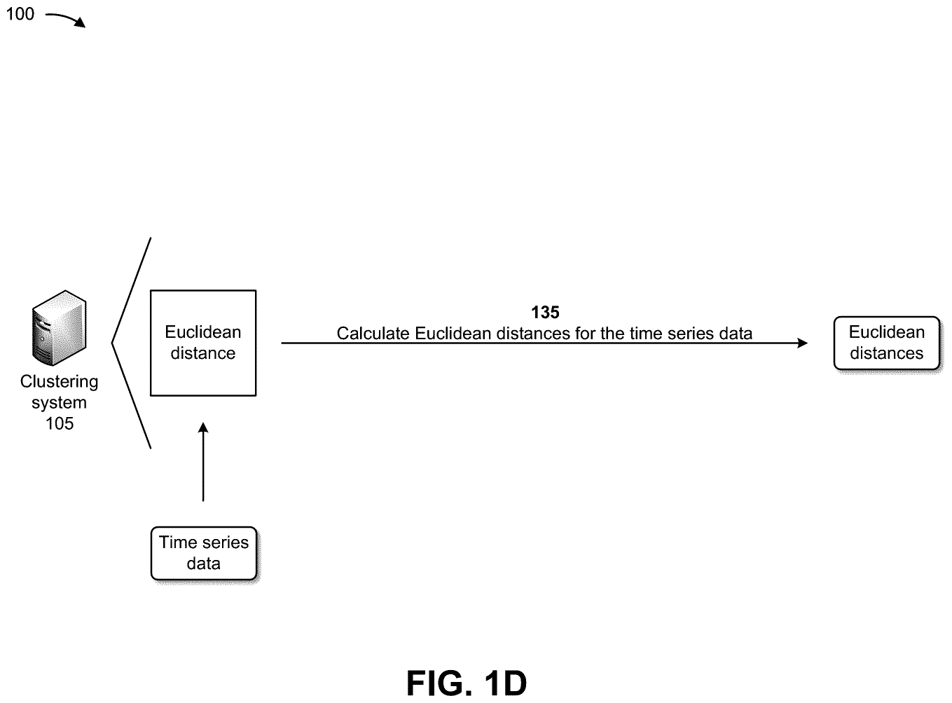

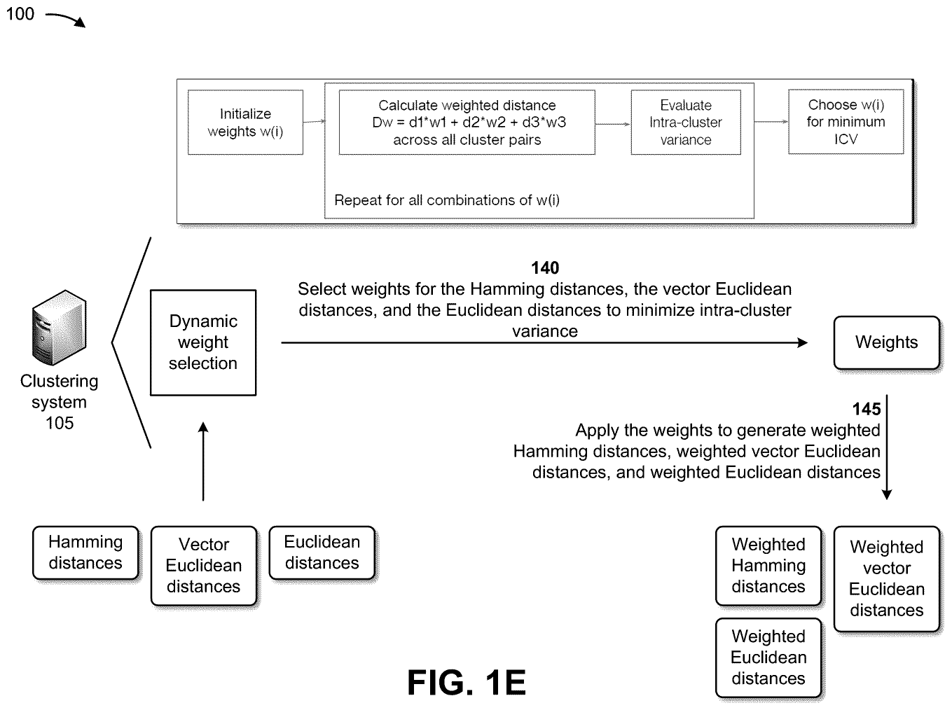

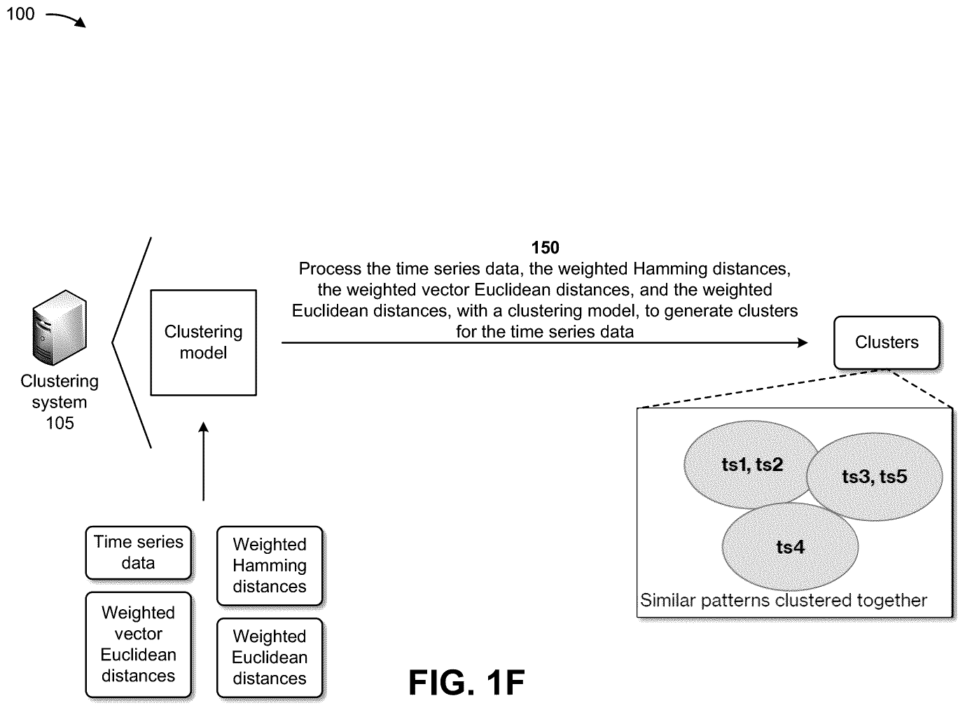

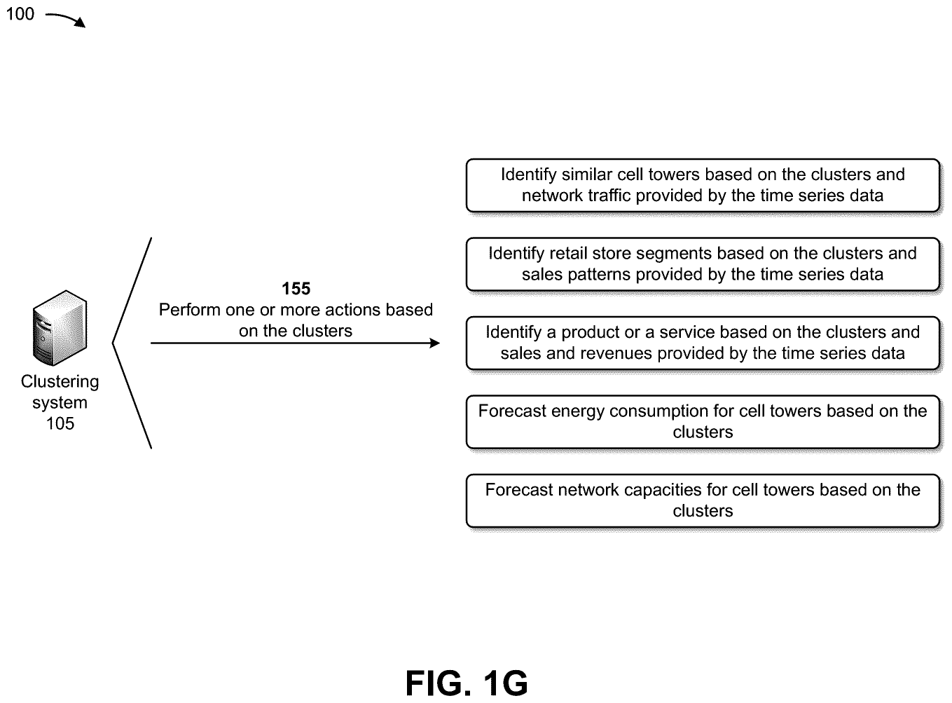

FIGS. 1A-1G are diagrams of an example 100 associated with clustering time series data based on pattern-focused distance metrics and dynamic weight selection. As shown in FIGS. 1A-1G, example 100 includes a clustering system 105 associated with a data structure. The clustering system 105 may include a system that clusters time series data based on pattern-focused distance metrics and dynamic weight selection. The data structure may include a database, a table, a list, and/or the like. Further details of the clustering system 105 and the data structure are provided elsewhere herein.

As shown in FIG. 1A, and by reference number 110, the clustering system 105 may receive time series data. For example, the data structure may store time series data, and the clustering system 105 may receive the time series data from the data structure. The time series data may include a sequence of data points indexed in time order. The data points may include successive measurements made from the same source over a fixed time interval and are used to track change over time. In some implementations, the clustering system 105 may continuously receive the time series data from the data structure, may periodically receive the time series data from the data structure, may receive the time series data from the data structure based on requesting the time series data from the data structure, and/or the like.

As further shown in FIG. 1A, and by reference number 115, the clustering system 105 may convert the time series data into binary data. For example, the clustering system 105 may represent the time series data as a binary sequence that indicates a crest or a trough. In some implementations, when converting the time series data into the binary data, the clustering system 105 may convert the time series data to binary strings that capture undulations over the time period of the time series data. For example, if a current value of the time series data is greater than a previous value of the time series, the clustering system 105 may convert the current value of the time series data to a one. If a current value of the time series data is less than a previous value of the time series, the clustering system 105 may convert the current value of the time series data to a zero. As shown in FIG. 1A, a first time step (t0) of the time series data has a value of “24,” a second time step (t1) of the time series data has a value of “36,” and a third time step (t2) of the time series data has a value of “12.” Therefore, the clustering system 105 may convert the second time step (t1) of the time series data to a one, and may convert the third time step (t2) of the time series data to a zero.

As shown in FIG. 1B, and by reference number 120, the clustering system 105 may calculate distances for the binary data. For example, a Hamming distance is a metric for comparing two binary data strings and may represent a number of bit positions in which the two binary data strings (e.g., two bits) are different. Since the binary data is a binary sequence that indicates a crest or a trough, the clustering system 105 may calculate the Hamming distances for the binary data by calculating the Hamming distances between sequences of the binary sequence. As shown in FIG. 1B, a first binary string (e.g., “101”) may represent a second time step (t1) being greater than a first time step (t0) (e.g., t1>t0), a third time step (t2) being less than the second time step (t1) (e.g., t2<t1), and a fourth time step (+3) being greater than the third time step (t2) (e.g., t3>t2). A second binary string (e.g., “011”) may represent the second time step (t1) being less than the first time step (t0) (e.g., t1<t0), the third time step (t2) being greater than the second time step (t1) (e.g., t2>t1), and the fourth time step (t3) being greater than the third time step (t2) (e.g., t3>t2). Based on these calculations, the first binary string and the second binary string may include two different bit positions.

As shown in FIG. 1C, and by reference number 125, the clustering system 105 may translate the time series data to vectors that capture patterns over a time period of the time series data. For example, the clustering system 105 may translate the time series data to vectors that quantify patterns (e.g., ups and downs) in the time series data. The clustering system 105 may calculate a deviation of a value at a current time step from recent trends in the time series data. The vectors may provide an indication of a direction and a magnitude of a pattern of the time series data. In some implementations, when translating the time series data to the vectors, the clustering system 105 may calculate an average of values for each of a plurality of time steps of the time series data, and may determine a deviation of each value of the time series data and the average. The clustering system 105 may generate the vectors based determining the deviation of each value of the time series data and the average. For example, the clustering system 105 may calculate an average of the values in recent time period (e.g., the past three time steps), and may evaluate a percent deviation of a value at a current time step with the average, as follows:

$$\% Deviation = \frac{t ( n )}{avg ( t ( n - 1 ) , t ( n - 2 ) , t ( n - 3 )} - 1.$$

The clustering system 105 may repeat the above calculation for each time step to generate a vector representation of the time series data.

As further shown in FIG. 1C, and by reference number 130, the clustering system 105 may calculate vector Euclidean distances for the vectors. For example, the clustering system 105 may calculate a distance (e.g., a Euclidean distance) between respective vectors. The vector Euclidean distances may include a distance metric that captures temporal variations of the time series data with respect to a trend component of the time series data. The Euclidean distance between two points in Euclidean space is a length of a line segment between the two points. The Euclidean distance may be calculated from Cartesian coordinates of the points using the Pythagorean theorem.

As shown in FIG. 1D, and by reference number 135, the clustering system 105 may calculate Euclidean distances for the time series data. For example, the clustering system 105 may calculate the Euclidean distances across the time series data. In some implementations, when calculating the Euclidean distances for the time series data, the clustering system 105 may calculate a distance between two time series as a straight-line distance between corresponding points of the time series.

As shown in FIG. 1E, and by reference number 140, the clustering system 105 may select weights for the Hamming distances, the vector Euclidean distances, and the Euclidean distances to minimize or decrease intra-cluster variance (e.g., maximize or increase intra-cluster similarity). For example, when selecting the weights for the Hamming distances, the vector Euclidean distances, and the Euclidean distances, the clustering system 105 may select the weights for the Hamming distances, the vector Euclidean distances, and the Euclidean distances to decrease intra-cluster variance for the time series data. In some implementations, when selecting the weights for the Hamming distances, the vector Euclidean distances, and the Euclidean distances, the clustering system 105 may select weights for the Hamming distances, the vector Euclidean distances, and the Euclidean distances to maximize or increase inter-cluster variance for the time series data (e.g., minimize or decrease inter-cluster similarity).

In some implementations, when selecting the weights for the Hamming distances, the vector Euclidean distances, and the Euclidean distances, the clustering system 105 may calculate weighted distances (Dw) for different combinations of the weights for the Hamming distances, the vector Euclidean distances, and the Euclidean distances, and may determine intra-cluster variances for the weighted distances. For example, a weighted distance (Dw) may be calculated as follows:

$$Dw = w 1 * d 1 + w 2 * d 2 + w 3 * d 3 , \sum wi = 1 ,$$

where d1 is the Hamming distances, d2 is the vector Euclidean distances, d3 is the Euclidean distances, w1 is the weight for the Hamming distances, w2 is the weight for the vector Euclidean distances, and w3 is the weight for the Euclidean distances. The clustering system may then select the weights for the Hamming distances, the vector Euclidean distances, and the Euclidean distances based on the intra-cluster variances.

In some implementations, when selecting the weights for the Hamming distances, the vector Euclidean distances, and the Euclidean distances, the clustering system 105 may iterate different combinations of the weights for the Hamming distances, the vector Euclidean distances, and the Euclidean distances to generate intra-cluster variances, and may apply a convergence criterion to the intra-cluster variances to select the weights for the Hamming distances, the vector Euclidean distances, and the Euclidean distances. For example, the clustering system 105 may initialize lower and upper limits for the weights (e.g., a Hamming distance limit between 0.3 and 0.6), and may initialize the weights (wi) and an iterator step for each metric (e.g., initial weights of 0.3 and an iterator step of 0.01). For each weight metric category, the clustering system 105 may iterate over the weight possibilities (e.g., minimum, maximum, or iterator step), may create a final weight metric (e.g., Σ_{w=1}Wᵢ*Dᵢ), may execute K-means clustering to create clusters, and may calculate an average intra-cluster variance based on the clusters. The clustering system 105 may apply the convergence criterion that identifies weights that minimize the intra-cluster variance.

In some implementations, the clustering system 105 may utilize one or more other distance metrics. For example, the clustering system 105 may utilize a direction focused distance metric, a magnitude focused distance metric, or a vectorized pattern distance. The direction focused distance metric may assume data to be in a vector space and may identify directional similarities between data points (e.g., vectors). The direction focused distance metric may include a Hamming distance, a cosine distance, and/or the like. The magnitude focused distance metric may include variants of a Minkowski distance that assumes data to be in a normed vector space (e.g., an n-dimensional real space) and may measure distances as a vector length. The magnitude focused distance metric may include a Euclidean distance (e.g., an L2 Norm), a Manhattan distance (e.g., an L1 norm), and/or the like. The vectorized pattern distance may include a hybrid distance metric created by combining weights from both the direction focused distance metric and the magnitude focused distance metric.

As further shown in FIG. 1E, and by reference number 145, the clustering system 105 may apply the weights to the Hamming distances, the vector Euclidean distances, and the Euclidean distances to generate weighted Hamming distances, weighted vector Euclidean distances, and weighted Euclidean distances. For example, once the weights are selected for the Hamming distances, the vector Euclidean distances, and the Euclidean distances, the clustering system 105 may apply the weights to the Hamming distances, the vector Euclidean distances, and the Euclidean distances to generate weighted Hamming distances, weighted vector Euclidean distances, and weighted Euclidean distances, as follows:

$$Weighted Hamming distances = w 1 * d 1$$

$$Weighted vector Euclidean distances = w 2 * d 2 , and$$

$$Weighted Euclidean distances = w 3 * d 3.$$

As shown in FIG. 1E, and by reference number 150, the clustering system 105 may process the time series data, the weighted Hamming distances, the weighted vector Euclidean distances, and the weighted Euclidean distances, with a clustering model, to generate clusters for the time series data. For example, the clustering system 105 may be associated with a clustering model, such as a K-means clustering model, a K-median clustering model, and/or the like. The clustering system 105 may utilize the clustering model with the time series data, the weighted Hamming distances, the weighted vector Euclidean distances, and the weighted Euclidean distances to generate the clusters for the time series data.

In some implementations, the clustering model may select a number K of clusters, and may select a random number K of points or centroids. The clustering model may assign each data point to a closest centroid, which will form predefined K clusters, may calculate an intra-cluster similarity, and may identify a new centroid for each cluster. The clustering model may repeat the assigning each data point to a closest centroid by reassigning each data point to a new closest centroid of each cluster. If any reassignment occurs, the clustering model may recalculate the intra-cluster similarity. In no reassignment occurs, the clustering model may output the clusters. The clustering model may create clusters that minimize intra-cluster variance (e.g., maximizes intra-cluster similarity). The less intra-cluster variance the more dense or homogeneous the clusters will be.

As shown in FIG. 1G, and by reference number 155, the clustering system 105 may perform one or more actions based on the clusters. In some implementations, performing the one or more actions includes the clustering system 105 identifying similar cell towers based on the clusters and network traffic provided by the time series data. For example, if the time series data is network traffic, the clustering system 105 may determine clusters associated with similar cell towers based on the network traffic. This may enable a network operator to implement similar policies for similar cell towers. More precise clustering, as described herein, may enable the network operator to more precisely implement similar policies for similar cell towers. In this way, the clustering system 105 conserves computing resources, networking resources, and/or other resources that would have otherwise been consumed by failing to cluster time series data based on magnitudes and a pattern behavior of the time series data.

In some implementations, performing the one or more actions includes the clustering system 105 identifying retail store segments based on the clusters and sales patterns provided by the time series data. For example, if the time series data is sales patterns of retail stores, the clustering system 105 may determine clusters associated with similar retail stores based on the sales patterns. This may enable a retail company to identify retail store segments based on the sales patterns of the retail stores. In this way, the clustering system 105 conserves computing resources, networking resources, and/or other resources that would have otherwise been consumed by failing to enable allocation of different weights to the magnitudes and a pattern behavior of the time series data.

In some implementations, performing the one or more actions includes the clustering system 105 identifying a product or a service based on the clusters and sales and revenues provided by the time series data. For example, if the time series data is sales and revenues associated with a product or a service, the clustering system 105 may determine clusters associated with similar products and/or services based on the sales and revenues. This may enable a company to identify which products and/or services are performing the best. In this way, the clustering system 105 conserves computing resources, networking resources, and/or other resources that would have otherwise been consumed by generating incorrect clusters due to failing to cluster the time series data based on the magnitudes and the pattern behavior of the time series data.

In some implementations, performing the one or more actions includes the clustering system 105 forecasting energy consumption for cell towers based on the clusters. For example, a network infrastructure may include thousands of cell sites. Energy consumption costs across these cell sites may contribute a significant portion of network operating costs. To be able to accurately predict the energy consumption across cell sites is imperative, but the energy consumption across cell sites may vary dramatically. As individual forecasting models would not be feasible for these diverse cell sites, the cell sites may be clustered based on energy consumption patterns over the months (e.g., where groups of cell sites with similar patterns are served by a single model for efficiency). In this way, the clustering system 105 conserves computing resources, networking resources, and/or other resources that would have otherwise been consumed by implementing incorrect decisions based on the incorrect clusters.

In some implementations, performing the one or more actions includes the clustering system 105 forecasting network capacities for cell towers based on the clusters. For example, a network infrastructure may include thousands of cell sites. Each of these cell sites may include a fixed capacity to serve customers, with one measure of capacity being a physical resource block unit (PRBU). A usage pattern may show daily seasonality (e.g., cell sites near offices show higher usage during office hours). It may be useful to forecast the PRBU at a cell site level to understand which cell sites may be at risk of reaching capacity and at what times. As individual forecasting models would not be feasible for these diverse cell sites, the cell sites may be clustered based on PRBU patterns over the months (e.g., where groups with similar patterns a served by a single model for efficiency). In this way, the clustering system 105 conserves computing resources, networking resources, and/or other resources that would have otherwise been consumed by failing to cluster time series data based on magnitudes and a pattern behavior of the time series data.

In this way, the clustering system clusters time series data based on pattern-focused distance metrics and dynamic weight selection. For example, the clustering system may provide a dynamically weighted distance definition for clustering of time series data in order to minimize intra-cluster variance and maximize the inter-cluster variance. The clustering system may linearly combine multiple distance measures to create a weighted distance metric. The clustering system may represent the time series data as binary data and may calculate hamming distances between the binary data. The clustering system may utilize custom distance metric that captures a temporal variation of the time series data with respect to a trend component of the time series data. With the weighted distance metric, the clustering system may extract a hybrid of these characteristics, resulting in coherent clusters. Thus, the clustering system may conserve computing resources, networking resources, and/or other resources that would have otherwise been consumed by failing to cluster time series data based on magnitudes and a pattern behavior of the time series data, failing to enable allocation of different weights to the magnitudes and a pattern behavior of the time series data, generating incorrect clusters due to failing to cluster the time series data based on the magnitudes and the pattern behavior of the time series data, implementing incorrect decisions based on the incorrect clusters, and/or the like.

As indicated above, FIGS. 1A-1G are provided as an example. Other examples may differ from what is described with regard to FIGS. 1A-1G. The number and arrangement of devices shown in FIGS. 1A-1G are provided as an example. In practice, there may be additional devices, fewer devices, different devices, or differently arranged devices than those shown in FIGS. 1A-1G. Furthermore, two or more devices shown in FIGS. 1A-1G may be implemented within a single device, or a single device shown in FIGS. 1A-1G may be implemented as multiple, distributed devices. Additionally, or alternatively, a set of devices (e.g., one or more devices) shown in FIGS. 1A-1G may perform one or more functions described as being performed by another set of devices shown in FIGS. 1A-1G.

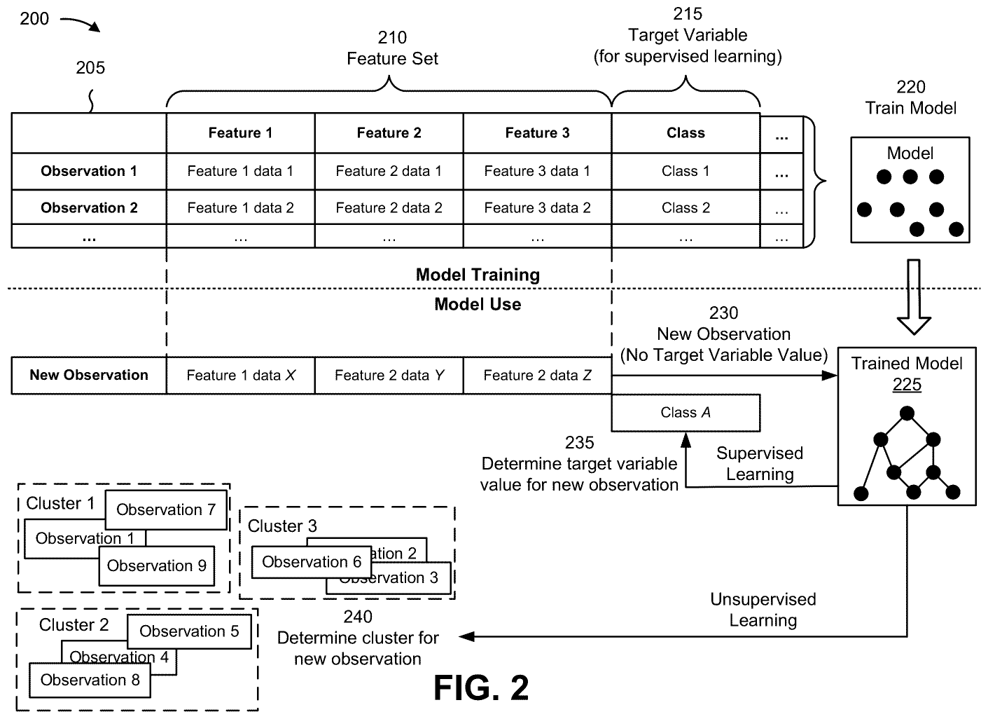

FIG. 2 is a diagram illustrating an example 200 of training and using a machine learning model. The machine learning model training and usage described herein may be performed using a machine learning system. The machine learning system may include or may be included in a computing device, a server, a cloud computing environment, or the like, such as the clustering system 105.

As shown by reference number 205, a machine learning model may be trained using a set of observations. The set of observations may be obtained from training data (e.g., historical data), such as data gathered during one or more processes described herein. In some implementations, the machine learning system may receive the set of observations (e.g., as input) from the clustering system 105, as described elsewhere herein.

As shown by reference number 210, the set of observations may include a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the clustering system 105. For example, the machine learning system may identify a feature set (e.g., one or more features and/or feature values) by extracting the feature set from structured data, by performing natural language processing to extract the feature set from unstructured data, and/or by receiving input from an operator.

As an example, a feature set for a set of observations may include a first feature of feature 1 data, a second feature of feature 2 data, a third feature of feature 3 data, and so on. As shown, for a first observation, the first feature may have a value of feature 1 data 1, the second feature may have a value of feature 2 data 1, the third feature may have a value of feature 3 data 1, and so on. For a second observation, the first feature may have a value of feature 1 data 2, the second feature may have a value of feature 2 data 2, the third feature may have a value of feature 3 data 2, and so on. These features and feature values are provided as examples, and may differ in other examples.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiples classes, classifications, or labels) and/or may represent a variable having a Boolean value. A target variable may be associated with a target variable value, and a target variable value may be specific to an observation. In example 200, the target variable is a class, which has a value of class 1 for the first observation and a value of class 2 for the second observation. The feature set and target variable described above are provided as examples, and other examples may differ from what is described above.

In some implementations, time series data and the machine learning model may be different from the information described above. For example, a single set of time series data may be available as opposed to multiple sets of observations. The machine learning model may forecast time series data as follows:

| | | | | | Forecasted Data | | | |
|---|---|---|---|---|---|---|---|---|
| | Training Data | | | | Time Step | Time Step | | Time Step |
| | Time Step 1 | Time Step 2 | . . . | Time Step n | n + 1 | n + 2 | . . . | n + k |
| Time | Time Series 1 | Time Series 1 | . . . | Time Series 1 | Forecasted | Forecasted | . . . | Forecasted |
| Series 1 | Data 1 | Data 2 | | Data n | Data 1 | Data 2 | | Data k |

In some implementations, the machine learning model utilize the following training data to generate the following unsupervised learning output:

| | | | | | Unsupervised |
|---|---|---|---|---|---|
| | | | | | Learning |
| | Training Data | | | | Output |
| | Time Step 1 | Time Step 2 | . . . | Time Step n | Class |
| Time | Time | Time | . . . | Time | 1 |
| Series 1 | Series 1 | Series 1 | | Series 1 | |
| | Data 1 | Data 2 | | Data n | |
| Time | Time | Time | . . . | Time | 2 |
| Series 2 | Series 2 | Series 2 | | Series 2 | |
| | Data 1 | Data 2 | | Data n | |

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, or the like. After training, the machine learning system may store the machine learning model as a trained machine learning model 225 to be used to analyze new observations.

As shown by reference number 230, the machine learning system may apply the trained machine learning model 225 to a new observation, such as by receiving a new observation and inputting the new observation to the trained machine learning model 225. As shown, the new observation may include a first feature of first time series data X, a second feature of second time series data Y, a third feature of third time series data Z, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, the trained machine learning model 225 may predict a value of clusters A for the target variable of clusters for the new observation, as shown by reference number 235. Based on this prediction, the machine learning system may provide a first recommendation, may provide output for determination of a first recommendation, may perform a first automated action, and/or may cause a first automated action to be performed (e.g., by instructing another device to perform the automated action), among other examples.

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., a first time series data cluster), then the machine learning system may provide a first recommendation. Additionally, or alternatively, the machine learning system may perform a first automated action and/or may cause a first automated action to be performed (e.g., by instructing another device to perform the automated action) based on classifying the new observation in the first cluster.

As another example, if the machine learning system were to classify the new observation in a second cluster (e.g., a second time series data cluster), then the machine learning system may provide a second (e.g., different) recommendation and/or may perform or cause performance of a second (e.g., different) automated action.

In some implementations, the recommendation and/or the automated action associated with the new observation may be based on a target variable value having a particular label (e.g., classification or categorization), may be based on whether a target variable value satisfies one or more threshold (e.g., whether the target variable value is greater than a threshold, is less than a threshold, is equal to a threshold, falls within a range of threshold values, or the like), and/or may be based on a cluster in which the new observation is classified.

In some implementations, the trained machine learning model 225 may be re-trained using feedback information. For example, feedback may be provided to the machine learning model. The feedback may be associated with actions performed based on the recommendations provided by the trained machine learning model 225 and/or automated actions performed, or caused, by the trained machine learning model 225. In other words, the recommendations and/or actions output by the trained machine learning model 225 may be used as inputs to re-train the machine learning model (e.g., a feedback loop may be used to train and/or update the machine learning model).

In this way, the machine learning system may apply a rigorous and automated process to cluster time series data based on pattern-focused distance metrics and dynamic weight selection. The machine learning system may enable recognition and/or identification of tens, hundreds, thousands, or millions of features and/or feature values for tens, hundreds, thousands, or millions of observations, thereby increasing accuracy and consistency and reducing delay associated with clustering time series data based on pattern-focused distance metrics and dynamic weight selection relative to requiring computing resources to be allocated for tens, hundreds, or thousands of operators to manually cluster time series data based on pattern-focused distance metrics and dynamic weight selection.

As indicated above, FIG. 2 is provided as an example. Other examples may differ from what is described in connection with FIG. 2.

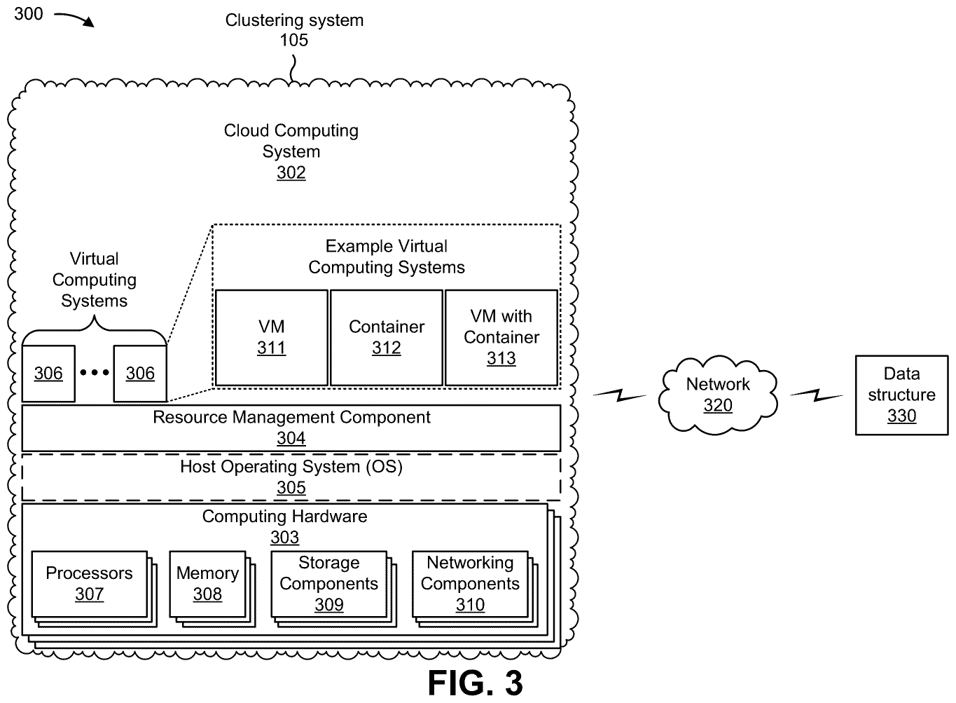

FIG. 3 is a diagram of an example environment 300 in which systems and/or methods described herein may be implemented. As shown in FIG. 3, the environment 300 may include the clustering system 105, which may include one or more elements of and/or may execute within a cloud computing system 302. The cloud computing system 302 may include one or more elements 303-313, as described in more detail below. As further shown in FIG. 3, the environment 300 may include a network 320 and/or a data structure 330. Devices and/or elements of the environment 300 may interconnect via wired connections and/or wireless connections.

The cloud computing system 302 includes computing hardware 303, a resource management component 304, a host operating system (OS) 305, and/or one or more virtual computing systems 306. The cloud computing system 302 may execute on, for example, an Amazon Web Services platform, a Microsoft Azure platform, or a Snowflake platform. The resource management component 304 may perform virtualization (e.g., abstraction) of the computing hardware 303 to create the one or more virtual computing systems 306. Using virtualization, the resource management component 304 enables a single computing device (e.g., a computer or a server) to operate like multiple computing devices, such as by creating multiple isolated virtual computing systems 306 from the computing hardware 303 of the single computing device. In this way, the computing hardware 303 can operate more efficiently, with lower power consumption, higher reliability, higher availability, higher utilization, greater flexibility, and lower cost than using separate computing devices.

The computing hardware 303 includes hardware and corresponding resources from one or more computing devices. For example, the computing hardware 303 may include hardware from a single computing device (e.g., a single server) or from multiple computing devices (e.g., multiple servers), such as multiple computing devices in one or more data centers. As shown, the computing hardware 303 may include one or more processors 307, one or more memories 308, one or more storage components 309, and/or one or more networking components 310. Examples of a processor, a memory, a storage component, and a networking component (e.g., a communication component) are described elsewhere herein.

The resource management component 304 includes a virtualization application (e.g., executing on hardware, such as the computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, or another type of hypervisor) or a virtual machine monitor, such as when the virtual computing systems 306 are virtual machines 311. Additionally, or alternatively, the resource management component 304 may include a container manager, such as when the virtual computing systems 306 are containers 312. In some implementations, the resource management component 304 executes within and/or in coordination with a host operating system 305.

A virtual computing system 306 includes a virtual environment that enables cloud-based execution of operations and/or processes described herein using the computing hardware 303. As shown, the virtual computing system 306 may include a virtual machine 311, a container 312, or a hybrid environment 313 that includes a virtual machine and a container, among other examples. The virtual computing system 306 may execute one or more applications using a file system that includes binary files, software libraries, and/or other resources required to execute applications on a guest operating system (e.g., within the virtual computing system 306) or the host operating system 305.

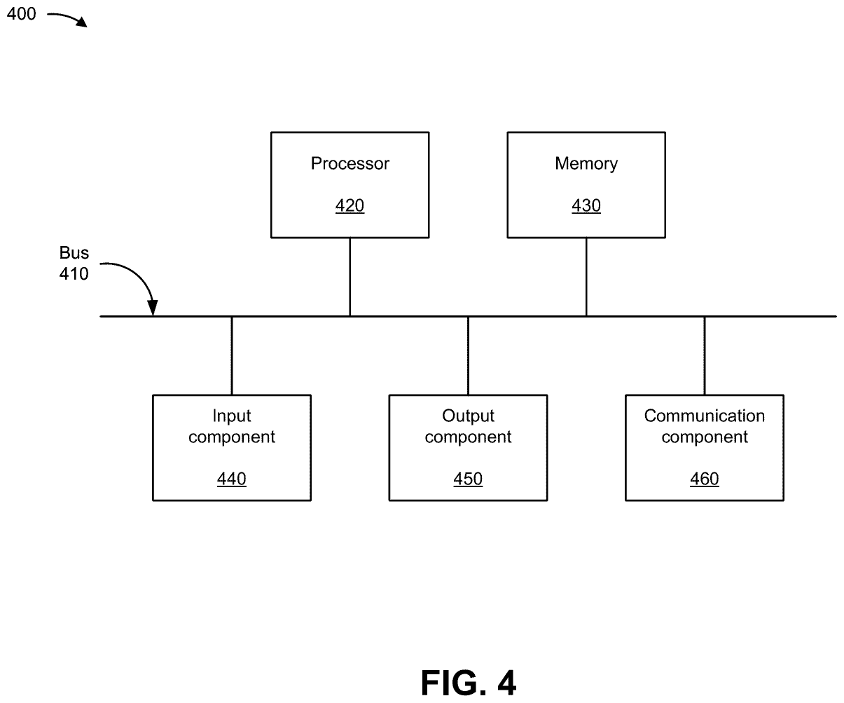

Although the clustering system 105 may include one or more elements 303-313 of the cloud computing system 302, may execute within the cloud computing system 302, and/or may be hosted within the cloud computing system 302, in some implementations, the clustering system 105 may not be cloud-based (e.g., may be implemented outside of a cloud computing system) or may be partially cloud-based. For example, the clustering system 105 may include one or more devices that are not part of the cloud computing system 302, such as a device 400 of FIG. 4, which may include a standalone server or another type of computing device. The clustering system 105 may perform one or more operations and/or processes described in more detail elsewhere herein.

The network 320 includes one or more wired and/or wireless networks. For example, the network 320 may include a cellular network, a public land mobile network (PLMN), a local area network (LAN), a wide area network (WAN), a private network, the Internet, and/or a combination of these or other types of networks. The network 320 enables communication among the devices of the environment 300.

The data structure 330 may include one or more devices capable of receiving, generating, storing, processing, and/or providing information, as described elsewhere herein. The data structure 330 may include a communication device and/or a computing device. For example, the data structure 330 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The data structure 330 may communicate with one or more other devices of environment 300, as described elsewhere herein.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400, which may correspond to the clustering system 105 and/or the data structure 330. In some implementations, the clustering system 105 and/or the data structure 330 may include one or more devices 400 and/or one or more components of the device 400. As shown in FIG. 4, the device 400 may include a bus 410, a processor 420, a memory 430, an input component 440, an output component 450, and a communication component 460.

The bus 410 includes one or more components that enable wired and/or wireless communication among the components of the device 400. The bus 410 may couple together two or more components of FIG. 4, such as via operative coupling, communicative coupling, electronic coupling, and/or electric coupling. The processor 420 includes a central processing unit, a graphics processing unit, a microprocessor, a controller, a microcontroller, a digital signal processor, a field-programmable gate array, an application-specific integrated circuit, and/or another type of processing component. The processor 420 is implemented in hardware, firmware, or a combination of hardware and software. In some implementations, the processor 420 includes one or more processors capable of being programmed to perform one or more operations or processes described elsewhere herein.

The memory 430 includes volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 stores information, instructions, and/or software (e.g., one or more software applications) related to the operation of the device 400. In some implementations, the memory 430 includes one or more memories that are coupled to one or more processors (e.g., the processor 420), such as via the bus 410.

The input component 440 enables the device 400 to receive input, such as user input and/or sensed input. For example, the input component 440 may include a touch screen, a keyboard, a keypad, a mouse, a button, a microphone, a switch, a sensor, a global positioning system sensor, an accelerometer, a gyroscope, and/or an actuator. The output component 450 enables the device 400 to provide output, such as via a display, a speaker, and/or a light-emitting diode. The communication component 460 enables the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., the memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

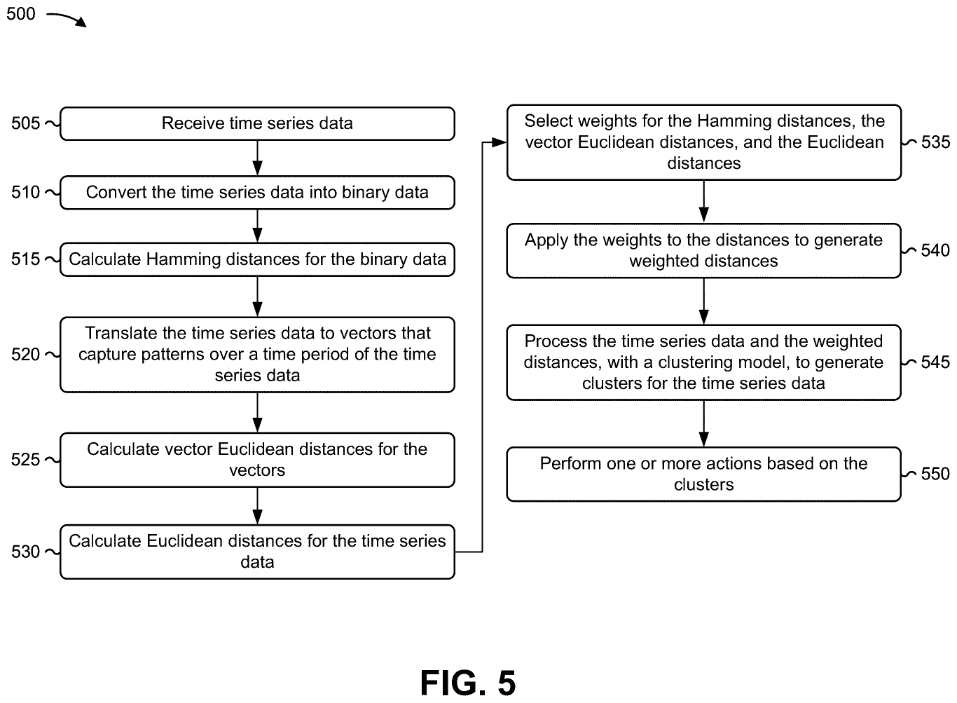

FIG. 5 depicts a flowchart of an example process 500 for clustering time series data based on pattern-focused distance metrics and dynamic weight selection. In some implementations, one or more process blocks of FIG. 5 may be performed by a device (e.g., the clustering system 105). In some implementations, one or more process blocks of FIG. 5 may be performed by another device or a group of devices separate from or including the device. Additionally, or alternatively, one or more process blocks of FIG. 5 may be performed by one or more components of the device 400, such as the processor 420, the memory 430, the input component 440, the output component 450, and/or the communication component 460.

As shown in FIG. 5, process 500 may include receiving time series data (block 505). For example, the device may receive time series data, as described above.

As further shown in FIG. 5, process 500 may include converting the time series data into binary data (block 510). For example, the device may convert the time series data into binary data, as described above. In some implementations, converting the time series data into the binary data includes converting the time series data to binary strings that capture undulations over the time period of the time series data.

As further shown in FIG. 5, process 500 may include calculating Hamming distances for the binary data (block 515). For example, the device may calculate Hamming distances for the binary data, as described above. In some implementations, each of the Hamming distances represents a quantity of bit positions in which two bits, of the binary data, are different.

As further shown in FIG. 5, process 500 may include translating the time series data to vectors that capture patterns over a time period of the time series data (block 520). For example, the device may translate the time series data to vectors that capture patterns over a time period of the time series data, as described above. In some implementations, translating the time series data to the vectors includes calculating an average of values for each of a plurality of time steps of the time series data, determining a deviation of each value of the time series data and the average, and generating the vectors based determining the deviation of each value of the time series data and the average.

As further shown in FIG. 5, process 500 may include calculating vector Euclidean distances for the vectors (block 525). For example, the device may calculate vector Euclidean distances for the vectors, as described above. In some implementations, the vector Euclidean distances represent distances between the vectors.

As further shown in FIG. 5, process 500 may include calculating Euclidean distances for the time series data (block 530). For example, the device may calculate Euclidean distances for the time series data, as described above.

As further shown in FIG. 5, process 500 may include selecting weights for the Hamming distances, the vector Euclidean distances, and the Euclidean distances (block 535). For example, the device may select weights for the Hamming distances, the vector Euclidean distances, and the Euclidean distances, as described above. In some implementations, selecting the weights for the Hamming distances, the vector Euclidean distances, and the Euclidean distances includes selecting the weights for the Hamming distances, the vector Euclidean distances, and the Euclidean distances to decrease intra-cluster variance for the time series data. In some implementations, selecting the weights for the Hamming distances, the vector Euclidean distances, and the Euclidean distances includes selecting weights for the Hamming distances, the vector Euclidean distances, and the Euclidean distances to increase inter-cluster variance for the time series data.

In some implementations, selecting the weights for the Hamming distances, the vector Euclidean distances, and the Euclidean distances includes calculating weighted distances for different combinations of the weights for the Hamming distances, the vector Euclidean distances, and the Euclidean distances, determining intra-cluster variances for the weighted distances, and selecting the weights for the Hamming distances, the vector Euclidean distances, and the Euclidean distances based on the intra-cluster variances. In some implementations, selecting the weights for the Hamming distances, the vector Euclidean distances, and the Euclidean distances includes iterating different combinations of the weights for the Hamming distances, the vector Euclidean distances, and the Euclidean distances to generate intra-cluster variances, and applying a convergence criterion to the intra-cluster variances to select the weights for the Hamming distances, the vector Euclidean distances, and the Euclidean distances.

As further shown in FIG. 5, process 500 may include applying the weights to the distances to generate weighted distances (block 540). For example, the device may apply the weights to the Hamming distances, the vector Euclidean distances, and the Euclidean distances to generate weighted Hamming distances, weighted vector Euclidean distances, and weighted Euclidean distances, as described above.

As further shown in FIG. 5, process 500 may include processing the time series data and the weighted distances, with a clustering model, to generate clusters for the time series data (block 545). For example, the device may process the time series data, the weighted Hamming distances, the weighted vector Euclidean distances, and the weighted Euclidean distances, with a clustering model, to generate clusters for the time series data, as described above.

As further shown in FIG. 5, process 500 may include performing one or more actions based on the clusters (block 550). For example, the device may perform one or more actions based on the clusters, as described above. In some implementations, performing the one or more actions includes identifying similar cell towers based on the clusters and network traffic provided by the time series data. In some implementations, performing the one or more actions includes identifying retail store segments based on the clusters and sales patterns provided by the time series data. In some implementations, performing the one or more actions includes identifying a product or a service based on the clusters and sales and revenues provided by the time series data. In some implementations, performing the one or more actions includes one or more of forecasting energy consumption for cell towers based on the clusters, or forecasting network capacities for cell towers based on the clusters.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
calculating, by a device, Hamming distances for binary data representing time series data;
translating, by the device, the time series data to vectors that capture patterns over a time period of the time series data;
calculating, by the device, vector Euclidean distances for the vectors;
calculating, by the device, Euclidean distances for the time series data;
selecting, by the device, weights for the Hamming distances, the vector Euclidean distances, and the Euclidean distances;
applying, by the device, the weights to the Hamming distances, the vector Euclidean distances, and the Euclidean distances to generate weighted Hamming distances, weighted vector Euclidean distances, and weighted Euclidean distances;
processing, by the device, the time series data, the weighted Hamming distances, the weighted vector Euclidean distances, and the weighted Euclidean distances, with a clustering model, to generate clusters for the time series data; and
performing, by the device, one or more actions based on the clusters.

2. The method of claim 1, further comprising:
converting the time series data into the binary data by converting the time series data to binary strings that capture undulations over the time period of the time series data.

3. The method of claim 1, wherein each of the Hamming distances represents a quantity of bit positions in which two bits, of the binary data, are different.

4. The method of claim 1, wherein translating the time series data to the vectors comprises:
calculating an average of values for each of a plurality of time steps of the time series data;
determining a deviation of each value of the time series data and the average; and
generating the vectors based determining the deviation of each value of the time series data and the average.

5. The method of claim 1, wherein the vector Euclidean distances represent distances between the vectors.

6. The method of claim 1, wherein selecting the weights for the Hamming distances, the vector Euclidean distances, and the Euclidean distances comprises:
selecting the weights for the Hamming distances, the vector Euclidean distances, and the Euclidean distances to decrease intra-cluster variance for the time series data.

7. The method of claim 1, wherein selecting the weights for the Hamming distances, the vector Euclidean distances, and the Euclidean distances comprises:
selecting weights for the Hamming distances, the vector Euclidean distances, and the Euclidean distances to increase inter-cluster variance for the time series data.

8. A device, comprising:
one or more processors configured to:
receive time series data;
convert the time series data into binary data,
wherein the binary data includes binary strings that capture undulations over a time period of the time series data;
calculate Hamming distances for the binary data;
translate the time series data to vectors that capture patterns over the time period of the time series data;
calculate vector Euclidean distances for the vectors;
calculate Euclidean distances for the time series data;
select weights for the Hamming distances, the vector Euclidean distances, and the Euclidean distances to decrease intra-cluster variance;
apply the weights to the Hamming distances, the vector Euclidean distances, and the Euclidean distances to generate weighted Hamming distances, weighted vector Euclidean distances, and weighted Euclidean distances;
process the time series data, the weighted Hamming distances, the weighted vector Euclidean distances, and the weighted Euclidean distances, with a clustering model, to generate clusters for the time series data; and
perform one or more actions based on the clusters.

9. The device of claim 8, wherein the one or more processors, to select the weights for the Hamming distances, the vector Euclidean distances, and the Euclidean distances, are configured to:
calculate weighted distances for different combinations of the weights for the Hamming distances, the vector Euclidean distances, and the Euclidean distances;
determine intra-cluster variances for the weighted distances; and
select the weights for the Hamming distances, the vector Euclidean distances, and the Euclidean distances based on the intra-cluster variances.

10. The device of claim 8, wherein the one or more processors, to select the weights for the Hamming distances, the vector Euclidean distances, and the Euclidean distances, are configured to:
iterate different combinations of the weights for the Hamming distances, the vector Euclidean distances, and the Euclidean distances to generate intra-cluster variances; and
apply a convergence criterion to the intra-cluster variances to select the weights for the Hamming distances, the vector Euclidean distances, and the Euclidean distances.

11. The device of claim 8, wherein the one or more processors, to perform the one or more actions, are configured to:
identify similar cell towers based on the clusters and network traffic provided by the time series data.

12. The device of claim 8, wherein the one or more processors, to perform the one or more actions, are configured to:
identify retail store segments based on the clusters and sales patterns provided by the time series data.

13. The device of claim 8, wherein the one or more processors, to perform the one or more actions, are configured to:
identify a product or a service based on the clusters and sales and revenues provided by the time series data.

14. The device of claim 8, wherein the one or more processors, to perform the one or more actions, are configured to one or more of:
forecast energy consumption for cell towers based on the clusters; or
forecast network capacities for cell towers based on the clusters.

15. A non-transitory computer-readable medium storing a set of instructions, the set of instructions comprising:
one or more instructions that, when executed by one or more processors of a device, cause the device to:
receive time series data;
convert the time series data into binary data;
calculate Hamming distances for the binary data,
wherein each of the Hamming distances represents a quantity of bit positions in which two bits, of the binary data, are different;
translate the time series data to vectors that capture patterns over a time period of the time series data;
calculate vector Euclidean distances for the vectors;
calculate Euclidean distances for the time series data;
select weights for the Hamming distances, the vector Euclidean distances, and the Euclidean distances;
apply the weights to the Hamming distances, the vector Euclidean distances, and the Euclidean distances to generate weighted Hamming distances, weighted vector Euclidean distances, and weighted Euclidean distances;
process the time series data, the weighted Hamming distances, the weighted vector Euclidean distances, and the weighted Euclidean distances, with a clustering model, to generate clusters for the time series data; and
perform one or more actions based on the clusters.

16. The non-transitory computer-readable medium of claim 15, wherein the one or more instructions, that cause the device to convert the time series data into the binary data, cause the device to:
convert the time series data to binary strings that capture undulations over the time period of the time series data.

17. The non-transitory computer-readable medium of claim 15, wherein the one or more instructions, that cause the device to translate the time series data to the vectors, cause the device to:
calculate an average of values for each of a plurality of time steps of the time series data;
determine a deviation of each value of the time series data and the average; and
generate the vectors based determining the deviation of each value of the time series data and the average.

18. The non-transitory computer-readable medium of claim 15, wherein the one or more instructions, that cause the device to select the weights for the Hamming distances, the vector Euclidean distances, and the Euclidean distances, cause the device to:
select weights for the Hamming distances, the vector Euclidean distances, and the Euclidean distances to decrease intra-cluster variance for the time series data and to increase inter-cluster variance for the time series data.

19. The non-transitory computer-readable medium of claim 15, wherein the one or more instructions, that cause the device to select the weights for the Hamming distances, the vector Euclidean distances, and the Euclidean distances, cause the device to:
calculate weighted distances for different combinations of the weights for the Hamming distances, the vector Euclidean distances, and the Euclidean distances;
determine intra-cluster variances for the weighted distances; and
select the weights for the Hamming distances, the vector Euclidean distances, and the Euclidean distances based on the intra-cluster variances.

20. The non-transitory computer-readable medium of claim 15, wherein the one or more instructions, that cause the device to select the weights for the Hamming distances, the vector Euclidean distances, and the Euclidean distances, cause the device to:
iterate different combinations of the weights for the Hamming distances, the vector Euclidean distances, and the Euclidean distances to generate intra-cluster variances; and
apply a convergence criterion to the intra-cluster variances to select the weights for the Hamming distances, the vector Euclidean distances, and the Euclidean distances.
